(19) United States
(12) Patent Application Publication
(10) Pub. No.: US 2005/0095322 A1
(43) Pub. Date: May 5, 2005

(54) Technology of cracker production to improve the condition of sick people

(76) Inventors: Irena Shtuktur, Migdal Haemek (IL); Emilya Gutman, Brooklyn, NY (US)

Correspondence Address: Emilya Gutman, 2418 Ave T, Brooklyn, NY, 11229, US

(21) Appl. No.: 10/719,845

(22) Filed: Nov. 24, 2003

(30) Foreign Application Priority Data
Nov. 3, 2003 (IL) 154 865/2

(51) Int. Cl. A23G 3/00

(52) U.S. Cl. 426/94

(57) ABSTRACT

This invention comprises the technological process of cracker production with addition of herbs possessing healing properties that improve the condition of people suffering from chronic diseases, namely, diabetes, high blood cholesterol, high blood pressure, and others. The healing effect of the product depends on the combination of herbs added to crackers during their production. In the existing technological process of cracker production the useful properties of herbal substances added to the dough during dough kneading are decreased during the process of baking. Our technology of cracker production with addition of herbs consists in adding herbal substances to crackers either before or after they are baked. Adding herbal substances after the process of baking is complete results in preserving the healing properties of herbal substances that otherwise are partially destroyed in the process of baking at the temperature of up to 200° C.

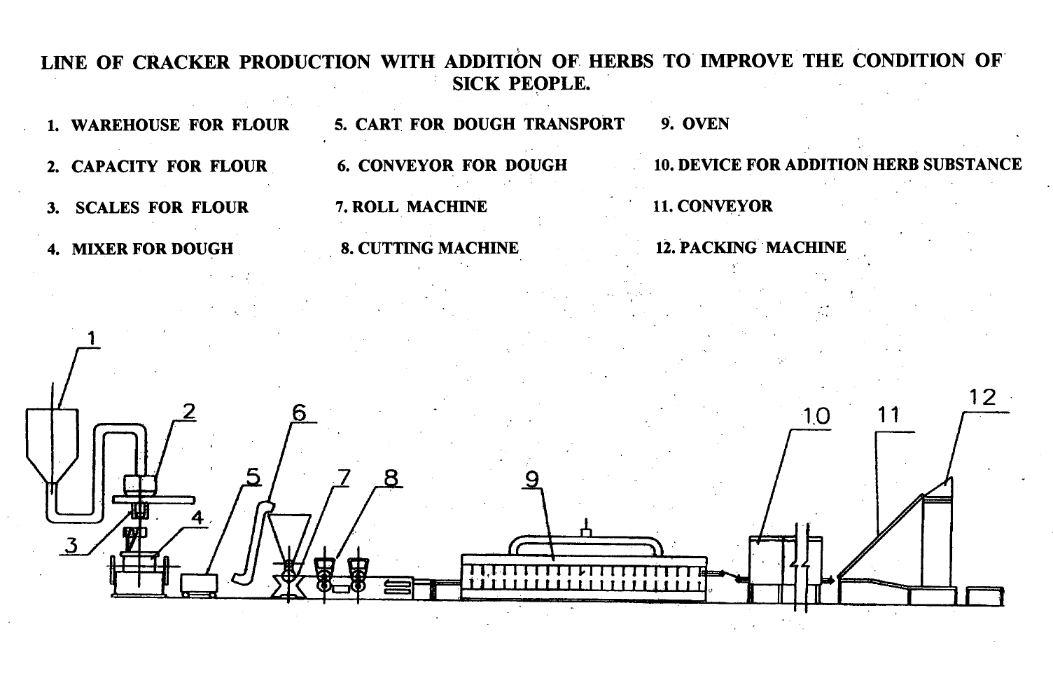

### CROSS-REFERENCE TO RELATED APPLICATIONS

The nonprovisional patent application #154865/2 “The Technology of Cracker Production with Addition of Herbs to Improve the Condition of Sick People” was filed in Israel by Irena Shtuktur on Mar. 11^{th}, 2003.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Food industry

### BRIEF SUMMARY OF THE INVENTION

This invention comprises the technological process of cracker production with addition of herbs possessing healing properties that improve the condition of people suffering from chronic diseases, namely, diabetes, high blood cholesterol, high blood pressure, and others. The healing effect of the product depends on the combination of herbs added to crackers during their production. For example, adding the extract of olive leaves improves the condition of people suffering from diabetes.

In the existing technological process of cracker production the useful properties of herbal substances added to the dough during dough kneading are decreased during the process of baking. Our technology of cracker production with addition of herbs has the following advantages:
1. It allows the addition of herbal substances to crackers either before or after they are baked. Adding herbal substances after the process of baking is complete, allows to fully preserve the healing properties of herbal substances that otherwise are partially destroyed in the process of baking at the temperature of up to 200° C.
2. Our technology allows us to produce such crackers possessing healing properties at any cracker manufacturing facility on the existing equipment without any additional investment requirements.

### BRIEF DESCRIPTION OF THE SEVERAL VIEWS OF THE DRAWING

The drawing that includes corresponding explanations is provided for this patent application.

### DETAILED DESCRIPTION OF THE INVENTION

Our technology allows producing crackers possessing healing properties by using three different methods. The choice of each method depends on certain requirements the product must satisfy and the type of equipment used by different cracker manufacturers.

The first method used in the technology of cracker production with addition of herbal substances to improve the condition of sick people consists in adding finely ground herbs or water, oil, or alcohol-based solutions of herbal substances into the dough during dough kneading before the process of baking begins.

The second method used in the technology of cracker production with addition of herbal substances consists of two sequential steps:
1. The first step consists in preparing an oil-based solution of herbal substances.
2. The second step consists in applying the above mentioned oil-based solution to the surface of crackers after the process of baking is complete. A cracker is used as a sponge that absorbs the oil-based solution of herbal substances.
The third method used in the technology of cracker production to improve the condition of sick people consists of three sequential steps:
1. The first step consists in preparing an alcohol-based solution of herbal substances.
2. The second step consists in applying the above mentioned alcohol-based solution to the surface of crackers after the process of baking is complete. This method, similarly to the second method, allows using a cracker as a sponge that absorbs the alcohol-based solution of herbal substances.
3. The third step consists in evaporating alcohol from the surface of a cracker at the temperature of 70° C.

1. The first claim regarding the technology of cracker production with addition of herbal substances to improve the condition of sick people consists in adding finely ground herbs or water, oil, or alcohol-based solutions of herbal substances into the dough during dough kneading before the process of baking begins.

2. The second claim regarding the technology of cracker production with addition of herbal substances consists of two sequential steps:
2.1 The first step consists in preparing an oil-based solution of herbal substances.
2.2 The second step consists in applying the above mentioned oil-based solution to the surface of crackers after the process of baking is complete. A cracker is used as a sponge that absorbs the oil-based solution of herbal substances.

3. The third claim regarding the technology of cracker production to improve the condition of sick people consists of three sequential steps:
3.1 The first step consists in preparing an alcohol-based solution of herbal substances.
3.2 The second step consists in applying the above mentioned alcohol-based solution to the surface of crackers after the process of baking is complete. This method, similarly to the second method, allows using a cracker as a sponge that absorbs the alcohol-based solution of herbal substances.
3.3 The third step consists in evaporating alcohol from the surface of a cracker at the temperature of 70° C.
